(19) United States
(12) Patent Application Publication
(10) Pub. No.: US 2018/0004233 A1
(43) Pub. Date: Jan. 4, 2018

(54) FLUID DISPENSER, FLUID DISPENSATION CONTROL DEVICE, AND FLUID DISPENSATION ABNORMAL STATUS MONITOR

(71) Applicant: Richtek Technology Corporation, Zhubei City (TW)

(72) Inventors: Shih-Chieh Lin, Kaohsiung (TW); Yu-Fu Kang, Taipei (TW); Chiung-Cheng Lo, Zhunan Township (TW)

(21) Appl. No.: 15/249,253

(22) Filed: Aug. 26, 2016

(30) Foreign Application Priority Data
Jun. 29, 2016 (TW) 105120434

(51) Int. Cl. G05D 7/06; F16K 1/04; B67D 7/32; B05B 12/08; B67D 7/12; B67D 7/04; F16K 1/12; B67D 7/42

(52) U.S. Cl. CPC G05D 7/0635; F16K 1/126; F16K 1/04; B67D 7/425; B05B 12/08; B67D 7/12; B67D 7/04; B67D 7/3218

(57) ABSTRACT

A fluid dispenser, includes: a fluid dispensation pipe, for receiving a fluid and controlling a dispensation the fluid; a MEMS sensor, for sensing a movement of the fluid dispenser, wherein when the movement is determined to be in an abnormal status, the MEMS sensor generates an alarm signal; and a dispensation stopper, for stopping the dispensation of the fluid according to the alarm signal.

### CROSS REFERENCE

The present invention claims priority to TW 105120434, filed on Jun. 29, 2016.

### BACKGROUND OF THE INVENTION

### Field of Invention

The present invention relates to a fluid dispenser; particularly, it relates to a fluid dispenser including a micro-electro-mechanical-system (MEMS) sensor for sensing an abnormal status of the fluid dispenser.

### Description of Related Art

Fluid dispensers, such as a gas pump nozzle, a shower head, etc., are often used in our daily life. When the fluid dispenser is in use, the fluid dispenser can be held by hand or fixed at a specific position. For example, when a gas pump nozzle is used to refuel a vehicle, it can be placed at a refueling port, or when a shower head is in use, it can be placed on a rack to provide a shower flow. Regardless whether the fluid dispenser is held by hand or fixed at a specific position, the fluid dispenser may fall from the position because of human or mechanical error, and the fall not only may cause a significant loss of the fluid, but may even cause a serious danger. For example, when the fluid in the fluid dispenser is a toxic chemical fluid, the fall of the fluid dispenser may cause a significant disaster.

The current gas pump nozzle can sense whether a fuel tank of a vehicle is full or not. When the fuel tank is full, the current gas pump nozzle can stop refueling. However, the current gas pump nozzle cannot sense whether it falls, so the possible danger and the fluid loss caused by the free fall of the current gas pump nozzle are not avoided.

In view of the above, to overcome the drawback in the prior art, the present invention proposes a fluid dispenser, which is capable of stopping the dispensation of the fluid in case of an abnormal status of the fluid dispenser.

### SUMMARY OF THE INVENTION

From one perspective, the present invention provides a fluid dispensation control device for use in a fluid dispenser. The fluid dispenser receives a fluid and controls a dispensation of the fluid. The fluid dispensation control device includes: a micro-electro-mechanical-system (MEMS) sensor, configured to sense a movement of the fluid dispenser, wherein when the movement is determined to be in an abnormal status, the MEMS sensor generates an alarm signal; and a dispensation stopper, configured to send a control signal to stop the dispensation of the fluid according to the alarm signal.

In one embodiment, the MEMS sensor includes: an accelerometer, an altitude meter, an angular velocity meter, a gyroscope, a gravity sensor, or a combination of two or more of the above.

In one embodiment, the abnormal status includes: the fluid dispenser being in a free fall status, a swing angle of the fluid dispenser being larger than a swing threshold, the fluid dispenser being in an impact status, a velocity variation of the fluid dispenser being larger than an acceleration threshold, the movement of the fluid dispenser corresponding to a predetermined movement, or a combination of two or more of the above.

In one embodiment, the MEMS sensor does not generate the alarm signal unless the abnormal status lasts over a predetermined time period, or, the MEMS sensor does not generate the alarm signal unless the abnormal status occurs within a predetermined time period.

In one embodiment, the predetermined movement includes: moving the fluid dispenser along a predetermined motion trajectory, moving the fluid dispenser to perform a predetermined gesture, or knocking the fluid dispenser.

In one embodiment, the fluid includes a liquid or a gas.

In one embodiment, the fluid dispensation control device further includes: a micro generator, configured to transform a flow energy of the fluid into electrical power, for providing the electrical power to the MEMS sensor and/or the dispensation stopper.

In one embodiment, the fluid dispenser includes: a shower head, a spray gun, a delivery gun, or a special dispensing gun.

From another perspective, the present invention provides a fluid dispensation abnormal status monitor for use in a fluid dispenser. The fluid dispenser receives a fluid and controls a dispensation of the fluid. The fluid dispensation abnormal status monitor includes: an abnormal status sensor, configured to sense a movement of the fluid dispenser, wherein when the movement is determined to be in an abnormal status, the abnormal status sensor generates an alarm signal; and a micro generator, configured to transform a flow energy of the fluid into electrical power, for providing the electrical power to the abnormal status sensor.

From another perspective, the present invention provides a fluid dispenser, which includes: a fluid dispensation pipe, including a dispensing valve configured to receive a fluid and control a dispensation of the fluid; a micro-electro-mechanical-system (MEMS) sensor, configured to sense a movement of the fluid dispenser, wherein when the movement is determined to be in an abnormal status, the MEMS sensor generates an alarm signal; and a dispensation stopper, configured to control the dispensing valve to stop the dispensation of the fluid according to the alarm signal.

In one embodiment, the dispensing valve includes: a flow control valve, a pressure control valve, or a directional control valve.

The objectives, technical details, features, and effects of the present invention will be better understood with regard to the detailed description of the embodiments below, with reference to the attached drawings.

### BRIEF DESCRIPTION OF THE DRAWINGS

FIGS. 1, 2, 3, and 4 show fluid dispensers according to embodiments of the present invention, respectively.

FIGS. 5A, 5B, 6A, 6B, 7A, 7B, 8A, 8B, 9A, and 9B show dispensing valves according to embodiments of the present invention, respectively.

### DESCRIPTION OF THE PREFERRED EMBODIMENTS

The above and other technical details, features and effects of the present invention will be better understood with regard to the detailed description of the embodiments below, with reference to the drawings. The drawings as referred to throughout the description of the present invention are for illustration only, to show the interrelations between the layers, but not drawn according to actual scale.

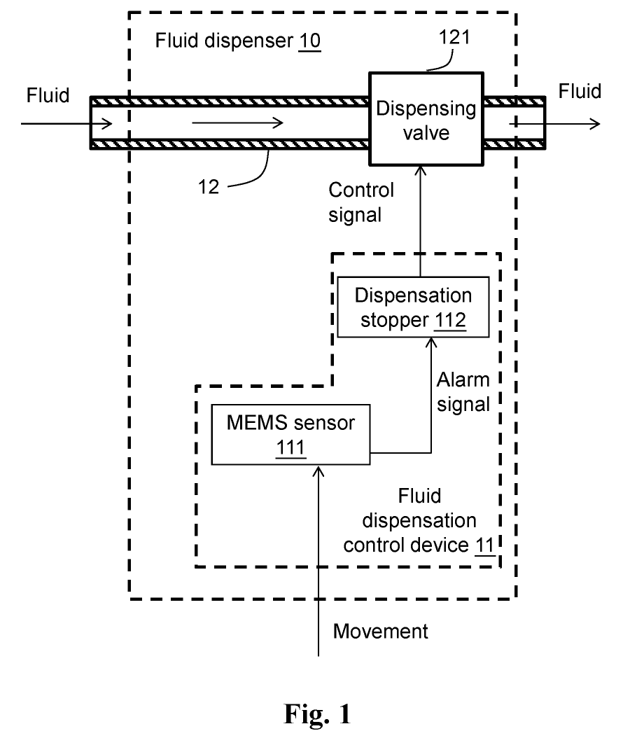

From one perspective, as shown in FIG. 1, the present invention provides a fluid dispensation control device 11, which is used in a fluid dispenser 10 for receiving a fluid and controlling a dispensation of the fluid. The fluid dispensation control device 11 includes: a micro-electro-mechanical-system (MEMS) sensor 111, configured to sense a movement of the fluid dispenser 10, wherein when the movement is determined to be in an abnormal status, the MEMS sensor 111 generates an alarm signal; and a dispensation stopper 112, configured to send a control signal to stop the dispensation of the fluid according to the alarm signal, for example by controlling the dispensing valve 121. The “abnormal status” can be defined according to the type and application environment of the fluid dispenser 10, or according to other factors; for example, one or more of the following conditions can be defined as “abnormal status”: the fluid dispenser 10 being in a free fall status, a swing angle of the fluid dispenser 10 being larger than a swing threshold, the fluid dispenser 10 being in an impact status, a velocity variation of the fluid dispenser 10 being larger than an acceleration threshold, the movement of the fluid dispenser 10 corresponding to a predetermined movement, or a combination of two or more of the above. For example, when the fluid dispenser 10 is in a free fall status, the MEMS sensor 111 senses this abnormal status and sends an alarm signal to the dispensation stopper 112; accordingly, the dispensation stopper 112 sends a control signal to stop dispensing the fluid. The present invention is capable of stopping the dispensation of the fluid according to an abnormal status which relates to a movement of the fluid dispenser 10; this function does not exist in the prior art.

In one embodiment, the fluid can include a liquid or a gas. More specifically, the liquid for example can be but is not limited to: water, oil, chemical liquid, solvent, cooling agent, washing agent, etc. The gas for example can be but is not limited to: flammable gas, chemical gas, inert gas, etc.

In one embodiment, the dispensing valve 121 can include: a flow control valve, a pressure control valve, or a directional control valve.

In one embodiment, the MEMS sensor 111 can include: an accelerometer, an altitude meter, an angular velocity meter, a gyroscope, a gravity sensor, or a combination of two or more of the above. For example, when the abnormal status is determined according to the acceleration or the velocity of the fluid dispenser 10, the MEMS sensor 111 can correspondingly include an accelerometer. Or, when the abnormal status is determined according to the altitude of the fluid dispenser 10, the MEMS sensor 111 can correspondingly include an altitude meter. Or, when the abnormal status is determined according to the swing of the fluid dispenser 10, the MEMS sensor 111 can correspondingly include an angular velocity meter or a gyroscope. Or, when the abnormal status is determined according to the gravity status of the fluid dispenser 10 (for example, whether it is in a free fall status), the MEMS sensor 111 can correspondingly include a gravity sensor. Thus, which kind of MENS sensor is used can be determined according to the application. Moreover, the abnormal status can be determined by two or more kinds of the dispenser movements, and correspondingly, the MEMS sensor 111 can be a combination of multiple sensors.

As described above, one or more of the following conditions can be defined as “abnormal status”: the fluid dispenser 10 being in a free fall status, a swing angle of the fluid dispenser 10 being larger than a swing threshold, the fluid dispenser 10 being in an impact status, a velocity variation of the fluid dispenser 10 being larger than an acceleration threshold, the movement of the fluid dispenser 10 corresponding to a predetermined movement, or a combination of two or more of the above. The free fall status indicates that the fluid dispenser 10 is falling; for example, it can indicate that a gas pump nozzle is falling from a refueling port, or that a shower head is falling from a rack, and accordingly, it is required to stop the fluid dispensation. In the embodiment that the abnormal status is determined by whether a swing angle of the fluid dispenser 10 is larger than a swing threshold, the abnormal status can indicate that the fluid dispenser 10 has fell off from a fixed position on a moving delivery car and now swings freely, so it is required to stop the fluid dispensation. In another embodiment, when a switch for controlling the fluid dispensation of the fluid dispenser 10 malfunctions, a user can move the fluid dispenser to perform a predetermined behavior (“predetermined movement”), and by detecting the predetermined movement, the fluid dispensation is forced to stop. The predetermined movement can be pre-defined in advance before the user uses the fluid dispenser 10; for example, the predetermined movement can be swinging the fluid dispenser 10 over a predefined number of times. The MEMS sensor 111 senses this predetermined movement and generates the alarm signal to stop the fluid dispensation. In another embodiment, the abnormal status is determined by whether the fluid dispenser 10 is in an impact status, and obviously when the fluid dispenser 10 is subject to an impact, the fluid dispensation should be stopped. To achieve this, in one embodiment, an acceleration threshold can be set for determining whether the fluid dispenser 10 is subject to an impact. At the moment of impact, the MEMS sensor 111 can sense a very high acceleration change. Therefore, when the MEMS sensor 111 senses an acceleration higher than the acceleration threshold, the movement of the fluid dispenser 10 can be determined to be abnormal and the fluid dispensation is forced to stop. In all of the above embodiments, the determination of the abnormal status can take into account the error/sensitivity of the MEMS sensor. For example, to determine whether the fluid dispenser 10 is in a free fall status, it is not required for the MEMS sensor 111 to sense an acceleration which is exactly equal to the gravity G. The MEMS sensor 111 can judge that the fluid dispenser 10 is in the free fall status when the acceleration of the fluid dispenser 10 is close to the acceleration of the gravity G.

In one embodiment, in addition to the aforementioned criteria to determine an abnormal status, time can be another factor to be included in the criteria for determining an abnormal status. For example, an abnormal status is not determined (and therefore the MEMS sensor 111 does not generate the alarm signal) unless it lasts over a predetermined time period, or it lasts for a period which is shorter than a predetermined time period. For example, in one embodiment, when the MEMS sensor 111 senses that the fluid dispenser 10 has an acceleration which is close to gravity G over a predetermined time period (for example, when an accelerometer senses the acceleration to be close to gravity G, or when a gravity sensor cannot sense a gravity reading or can sense only a very little gravity), it is determined that the fluid dispenser 10 is in the free fall status. Or, when the MEMS sensor 111 senses an altitude decrease which occurs within a predetermined time period and the altitude decrease is larger than an altitude threshold, it is determined that the fluid dispenser 10 is in the free fall status. In the previous example, it is required for the acceleration of gravity G to last over a predetermined time period, while in the next example, it is required for the large altitude decrease to occur within a predetermined time period.

The duration of the predetermined time period can be decided according to several factors. For example, it should be considered as to whether the duration is long enough to correctly judge the status of the fluid dispenser 10; on the other hand, it should be considered as to whether the duration is too long so that the fluid loss is excessive to increase the risk. A suitable duration of time period can be decided according to a desired trade-off among several factors.

In one embodiment, an abnormal status is determined when the movement of the fluid dispenser 10 corresponds to a predetermined movement. This predetermined movement for example can be, but is not limited to, “swinging the fluid dispenser 10 over a predefined number of times” as mentioned in the above; that is, swinging can be one form of the predetermined movement. In another embodiment, for example, the predetermined movement can include moving the fluid dispenser 10 along a predetermined motion trajectory, such as a circular movement over a predetermined angle, or moving the fluid dispenser 10 to perform a predetermined gesture, or knocking the fluid dispenser 10. When the fluid dispenser 10 malfunctions, the user can perform the predetermined gesture or knock the fluid dispenser 10 to stop the fluid dispensation. The knocking action for example can include single or plural knocks. In case of plural knocks, it can be defined that the intervals between the knocks should be the same or different. If the intervals between the knocks are different, it is easier to avoid confusing the knocks with a resonant sound in the fluid dispensation pipe 12 with a fixed frequency.

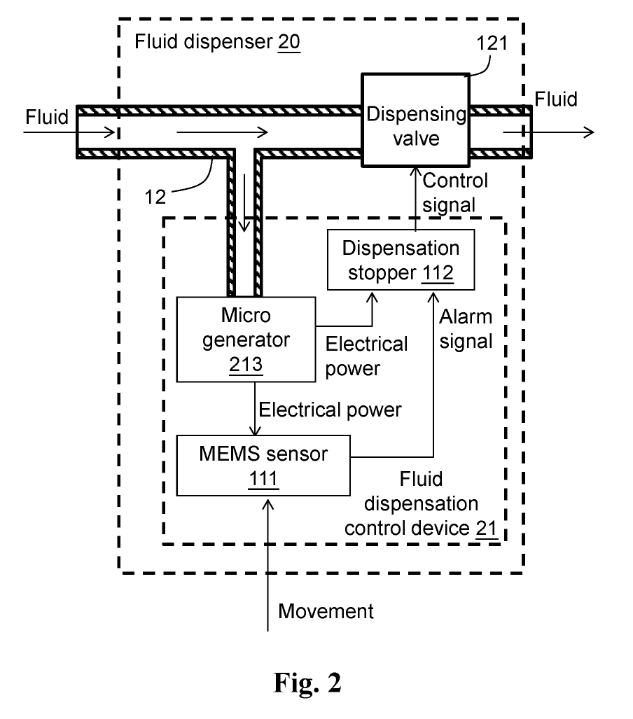

FIG. 2 shows a fluid dispenser 20 according to another embodiment of the present invention. The fluid dispenser 20 includes a fluid dispensation control device 21, which includes the MEMS sensor 111 and the dispensation stopper 112 which are similarly included in the fluid dispenser 10 of the aforementioned embodiment. The fluid dispensation control device 21 further includes a micro generator 213 which is in a location that communicates with the fluid dispensation pipe 12, in order to transform a flow energy of the fluid in the fluid dispensation pipe 12 into electrical power, for providing the electrical power to the MEMS sensor 111 and/or the dispensation stopper 112. In more detail, the micro generator 213 can be located at a position in a bypass pipe of the fluid dispensation pipe 12, or at a position which communicates with a bypass pipe of the fluid dispensation pipe 12, to transform the flow energy of the fluid in the bypass pipe into the electrical power. The flow energy can be in any of the forms of: pressure, impulse, momentum, speed, temperature, or other forms of energy. The MEMS sensor 111 and the dispensation stopper 112 do not require much power, because the MEMS sensor 111 and the dispensation stopper 112 work only when there is fluid flowing in the fluid dispensation pipe 12. The electrical power generated by the micro generator 213 is enough for the operation of the MEMS sensor 111 and the dispensation stopper 112. However if necessary, a storage device such as capacitor (not shown) can be included in the fluid dispenser 20 for storing the energy/power generated by the micro generator 213. In the embodiment shown in FIG. 2, the electrical power for the fluid dispensation control device 21 is supplied by the micro generator 213, whereby a battery or components to connect to an external power supply are not necessary, such that the cost, space, and weight of the fluid dispenser 20 can be reduced. However, it is still within the spirit of the present invention if the fluid dispenser does not include a micro generator but relies on a battery or an external power supply to supply power.

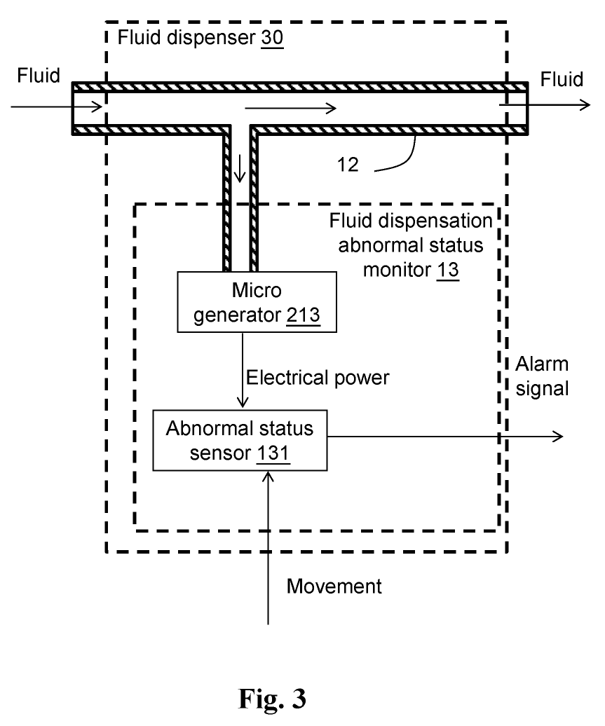

From another perspective, as shown in FIG. 3, the present invention provides a fluid dispensation abnormal status monitor 13 for use in a fluid dispenser 30; the fluid dispenser 30 receives a fluid and controls a dispensation of the fluid. The fluid dispensation abnormal status monitor 13 includes: an abnormal status sensor 131, configured to sense a movement of the fluid dispenser 30, wherein when the movement is determined to be in an abnormal status, the abnormal status sensor 131 generates an alarm signal; and a micro generator 213, configured to transform a flow energy of the fluid into electrical power, for providing the electrical power to the abnormal status sensor 131. This embodiment is different from the previous embodiment in that: when the abnormal status occurs, the fluid dispensation in this embodiment does not have to be stopped; it is only required to send out an alarm signal. Therefore, the dispensation stopper can be omitted in this embodiment. The alarm signal for example can be, but is not limited to, a warning sound, a warning light, and/or a warning text message generated at the site of the fluid dispenser 30, and/or a warning information sent to a remote site by wireless, cable, local network or Internet communication, etc., or a combination of two or more of the above.

In one embodiment, the abnormal status sensor 131 includes the MEMS sensor 111.

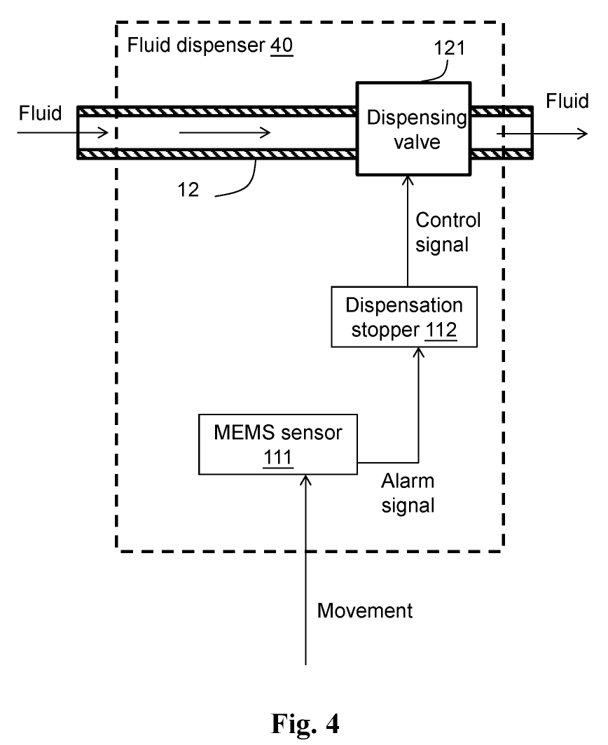

From another perspective, as shown in FIG. 4, the present invention provides a fluid dispenser 40, which includes: a fluid dispensation pipe 12, including a dispensing valve 121 for receiving a fluid and controlling a dispensation of the fluid; a micro-electro-mechanical-system (MEMS) sensor 111, configured to sense a movement of the fluid dispenser 40, wherein when the movement is determined to be in an abnormal status, the MEMS sensor 111 generates an alarm signal; and a dispensation stopper 112, configured to control the dispensing valve 121 so as to stop the dispensation of the fluid according to the alarm signal. This embodiment is different from the fluid dispenser 10 in FIG. 1 in that the MEMS sensor 111 and the dispensation stopper 112 are separately disposed in the fluid dispensation device 11 instead of being integrated in one module.

The fluid dispensers 10, 20, 30, and 40 for example can be, but are not limited to: a shower head, a spray gun, a delivery gun, or a special dispensing gun.

In one embodiment, according to the practical need, the dispensing valve 121 can include: a flow control valve, a pressure control valve, or a directional control valve.

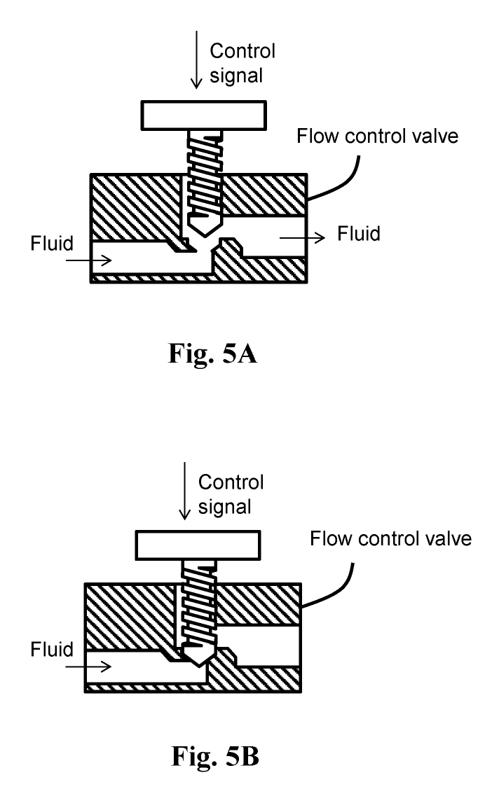

FIGS. 5A and 5B show one embodiment of the dispensing valve, wherein the dispensing valve is a flow control valve. As shown in FIG. 5A, the flow control valve receives the fluid from one side of the flow control valve, and dispenses the fluid to the other side. When the MEMS sensor 111 senses the abnormal status, the MEMS sensor 111 sends the alarm signal to the dispensation stopper 112, and the dispensation stopper 112 generates a control signal according to the alarm signal. FIG. 5B shows that the flow control valve stops the fluid dispensation according to the control signal. What FIGS. 5A and 5B show is one embodiment of the flow control valve; the flow control valve can be of a different type and it can stop the fluid dispensation according to the control signal by another way.

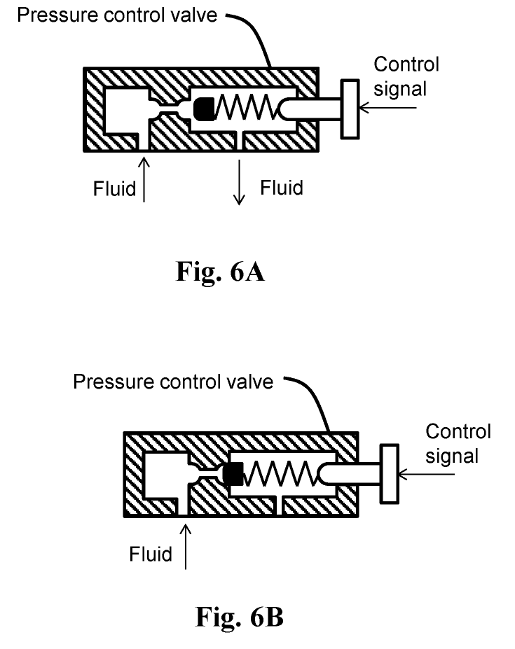

FIGS. 6A and 6B show one embodiment of the dispensing valve, wherein the dispensing valve is a pressure control valve. As shown in FIG. 6A, the pressure control valve receives the fluid from one side of the pressure control valve, and dispenses the fluid to the other side. When the MEMS sensor 111 senses the abnormal status, the MEMS sensor 111 sends the alarm signal to the dispensation stopper 112, and the dispensation stopper 112 generates a control signal according to the alarm signal. FIG. 6B shows that the pressure control valve stops the fluid dispensation according to the control signal.

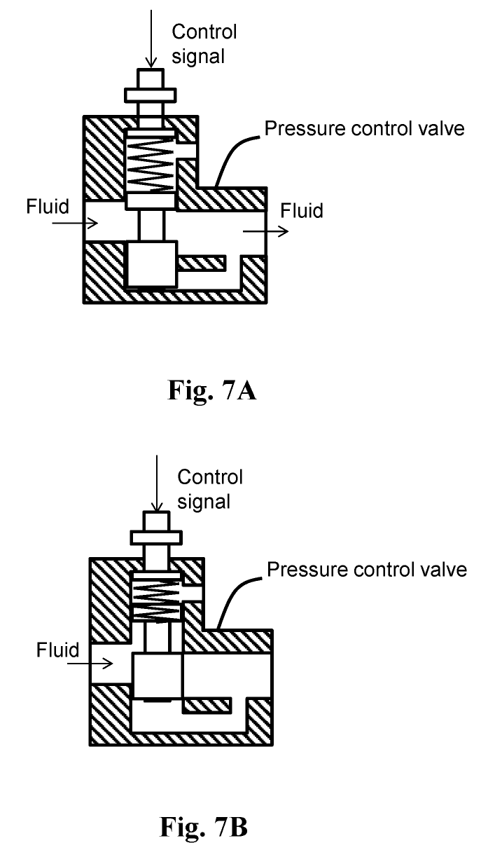

FIGS. 7A and 7B show one embodiment of the dispensing valve, wherein the dispensing valve is in another type of the pressure control valve. Similarly, when the MEMS sensor 111 senses the abnormal status, the MEMS sensor 111 sends the alarm signal to the dispensation stopper 112, and the dispensation stopper 112 generates a control signal according to the alarm signal. FIG. 7B shows that the pressure control valve stops the fluid dispensation according to the control signal.

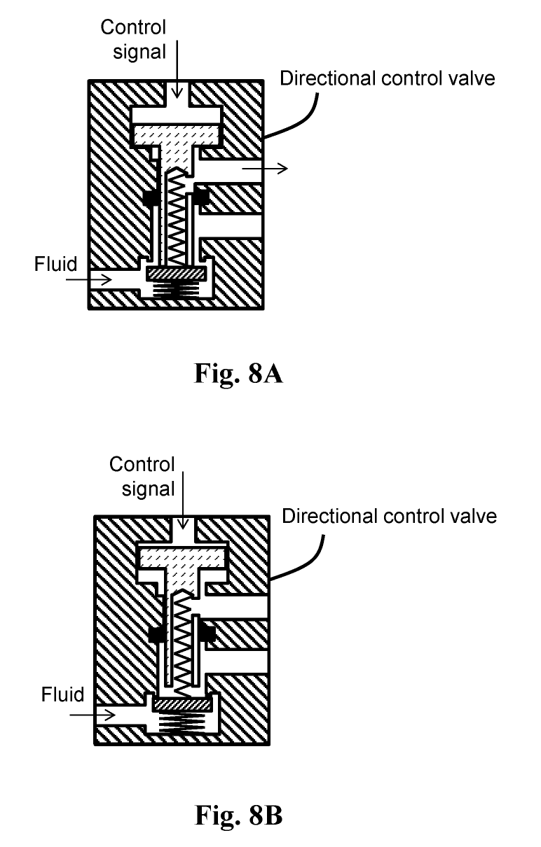

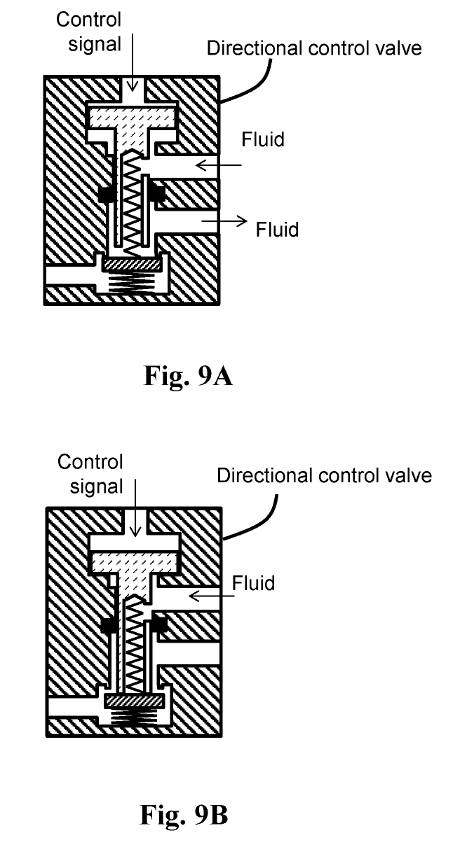

FIGS. 8A and 8B show one embodiment of the dispensing valve, wherein the dispensing valve is a directional control valve. As shown in FIG. 8A, the directional control valve receives the fluid from the lower left side of the directional control valve, and dispenses the fluid to the upper right side. When the MEMS sensor 111 senses the abnormal status, the MEMS sensor 111 sends the alarm signal to the dispensation stopper 112, and the dispensation stopper 112 generates a control signal according to the alarm signal. FIG. 8B shows that the directional control valve stops the fluid dispensation according to the control signal. The directional control valve shown in FIGS. 8A and 8B has two different fluid paths. FIGS. 9A and 9B show another embodiment of the fluid path which is different from the embodiment shown in FIGS. 8A and 8B. In FIG. 8A, the fluid inlet is at the lower left side, and the fluid outlet is at the upper right side. In FIG. 9A, the fluid inlet is at the upper right side, and the fluid outlet is at the lower right side. When the MEMS sensor 111 senses the abnormal status, the MEMS sensor 111 sends the alarm signal to the dispensation stopper 112, and the dispensation stopper 112 generates a control signal according to the alarm signal. FIG. 9B shows that the directional control valve stops the fluid dispensation according to the control signal.

In the embodiments shown in FIGS. 5A, 5B, 6A, 6B, 7A, 7B, 8A, 8B, 9A, and 9B, the control signals can be in the form of electrical signals, magnetic signals, pressure, fluid, mechanical forces, etc.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. In view of the foregoing, the spirit of the present invention should cover all such and other modifications and variations, which should be interpreted to fall within the scope of the following claims and their equivalents.

What is claimed is:

1. A fluid dispensation control device for use in a fluid dispenser, the fluid dispenser receiving a fluid and controlling a dispensation of the fluid, the fluid dispensation control device comprising:
a micro-electro-mechanical-system (MEMS) sensor, configured to sense a movement of the fluid dispenser, wherein when the movement is determined to be in an abnormal status, the MEMS sensor generates an alarm signal; and
a dispensation stopper, configured to send a control signal to stop the dispensation of the fluid according to the alarm signal.

2. The fluid dispensation control device of claim 1, wherein the MEMS sensor includes: an accelerometer, an altitude meter, an angular velocity meter, a gyroscope, a gravity sensor, or a combination of two or more of the above.

3. The fluid dispensation control device of claim 1, wherein the abnormal status includes: the fluid dispenser being in a free fall status, a swing angle of the fluid dispenser being larger than a swing threshold, the fluid dispenser being in an impact status, a velocity variation of the fluid dispenser being larger than an acceleration threshold, the movement of the fluid dispenser corresponding to a predetermined movement, or a combination of two or more of the above.

4. The fluid dispensation control device of claim 3, wherein the predetermined movement includes: moving the fluid dispenser along a predetermined motion trajectory, moving the fluid dispenser to perform a predetermined gesture, or knocking the fluid dispenser.

5. The fluid dispensation control device of claim 1, wherein the MEMS sensor does not generate the alarm signal unless the abnormal status lasts over a predetermined time period, or, the MEMS sensor does not generate the alarm signal unless the abnormal status occurs within a predetermined time period.

6. The fluid dispensation control device of claim 1, wherein the fluid includes a liquid or a gas.

7. The fluid dispensation control device of claim 1, further comprising: a micro generator, configured to transform a flow energy of the fluid into electrical power, for providing the electrical power to the MEMS sensor and/or the dispensation stopper.

8. The fluid dispensation control device of claim 1, wherein the fluid dispenser includes: a shower head, a spray gun, a delivery gun, or a special dispensing gun.

9. A fluid dispensation abnormal status monitor for use in a fluid dispenser, the fluid dispenser receiving a fluid and controlling a dispensation of the fluid, the fluid dispensation abnormal status monitor comprising:
an abnormal status sensor, configured to sense a movement of the fluid dispenser, wherein when the movement is determined to be in an abnormal status, the abnormal status sensor generates an alarm signal; and
a micro generator, configured to transform a flow energy of the fluid into electrical power, for providing the electrical power to the abnormal status sensor.

10. The fluid dispensation abnormal status monitor of claim 9, wherein the abnormal status sensor includes: an accelerometer, an altitude meter, an angular velocity meter, a gyroscope, a gravity sensor, or a combination of two or more of the above.

11. The fluid dispensation abnormal status monitor of claim 9, wherein the abnormal status includes: the fluid dispenser being in a free fall status, a swing angle of the fluid dispenser being larger than a swing threshold, the fluid dispenser being in an impact status, a velocity variation of the fluid dispenser being larger than an acceleration threshold, the movement of the fluid dispenser corresponding to a predetermined movement, or a combination of two or more of the above.

12. The fluid dispensation abnormal status monitor of claim 9, wherein the abnormal status sensor does not generate the alarm signal unless the abnormal status lasts over a predetermined time period, or, the abnormal status sensor does not generate the alarm signal unless the abnormal status occurs within a predetermined time period.

13. A fluid dispenser, comprising:
a fluid dispensation pipe, including a dispensing valve configured to receive a fluid and control a dispensation of the fluid;
a micro-electro-mechanical-system (MEMS) sensor, configured to sense a movement of the fluid dispenser, wherein when the movement is determined to be in an abnormal status, the MEMS sensor generates an alarm signal; and
a dispensation stopper, configured to control the dispensing valve so as to stop the dispensation of the fluid according to the alarm signal.

14. The fluid dispenser of claim 13, further comprising a micro generator, configured to transform a flow energy of the fluid into electrical power, for providing the electrical power to the MEMS sensor.

15. The fluid dispenser of claim 13, wherein the dispensing valve includes: a flow control valve, a pressure control valve, or a directional control valve.
